(19) United States
(12) Patent Application Publication
(10) Pub. No.: US 2018/0250796 A1
(43) Pub. Date: Sep. 6, 2018

(54) RATCHET WRENCH

(71) Applicants: CHUN-WEI YANG, Taichung (TW); ZHE-PING ZHANG, Taichung (TW)

(72) Inventors: CHUN-WEI YANG, Taichung (TW); ZHE-PING ZHANG, Taichung (TW)

(21) Appl. No.: 15/450,021

(22) Filed: Mar. 5, 2017

(51) Int. Cl. B25B 13/46; B25B 23/00

(52) U.S. Cl. CPC B25B 13/463; B25B 23/0007

(57) ABSTRACT

A ratchet wrench includes a body which has a through hole, a first recess, a second recess, a top recessed area and a bottom recessed area to accommodate the ratchet wheel, the pawl, the switch unit, the top ring, the bottom ring, the top clip and the bottom clip. The ratchet wheel has a first pivotal portion, a top groove, a second pivotal portion and a bottom groove. The pawl has a notch. The switch unit is pivoted to control the movement of the pawl in the first recess. The top ring is located in the top recessed area and the bottom ring is located in the bottom recessed area. The top clip and the bottom clip respectively position the ratchet wheel, and restrict the top ring and the bottom ring from dropping from the body.

The present invention is a Continuation-In-Part application of applicant's former application with the application Ser. No. 15/424,761, filed on Feb. 3, 2017.

### BACKGROUND OF THE INVENTION

### 1. Fields of the Invention

### 2. Descriptions of Related Art

The conventional ratchet wrench known to applicant is disclosed in U.S. Pat. No. 6,282,992, and comprises a handle; a head extended from the handle and including a hole, a web being defined between the handle and the head, a cavity being defined in the web and communicated with the hole, the web further including a compartment having a first end communicated with the cavity and a second end communicated with outside, thereby leaving a bridge in the web; a drive member rotatably mounted in the hole of the head, the drive member including a plurality of teeth formed on an outer periphery thereof; a pawl mounted in the cavity and including a first side with a plurality of ratchet teeth for releasably engaging with the teeth of the drive member; a switch member including a turn-piece for manual operation and an actuating plate extended from the turn-piece and rotatably received in the second end of the compartment of the web, the switch member being switchable between two positions for changing ratcheting direction of the drive member; an elastic element and a peg mounted in the cavity and between the pawl and the actuating plate, with the peg being received in the elastic element and in the receptacle, with the peg and the elastic element being rotatable with the actuating plate, the pawl further including a second side with a recess, the peg having a first end movably received in the recess of the pawl and a second end, the elastic element biasing the second end of the peg for exerting a force to the peg toward the pawl, thereby urging the ratchet teeth of the pawl to engage with the teeth of the drive member, wherein the elastic element includes a first end received in the receptacle and a second end outside the receptacle and configured to be attached to the actuating plate, the second end of the peg being received in the elastic element, the first end of the elastic element being configured to bias the second end of the peg toward the recess of the pawl by having the elastic element under tension between the receptacle and the peg; wherein an inner periphery defining the hole of the head includes a first annular groove, and wherein the outer periphery of the drive member includes a second annular groove; and a C-clip received in the first annular groove and the second annular groove, thereby rotatably retaining the drive member in the head.

However, the cavity includes a closed top and a closed bottom, so that only T-shaped blade can be used to make the cavity when manufacturing the head of the wrench. The T-shaped blade is an expensive tool and the size of shank of the T-shaped blade is restricted by the inner periphery of the head so that the shank is easily broken. Furthermore, the hole includes two different diameters which are difficult to be drilled.

The present invention intends to provide a ratchet wrench which is easily manufactured so as to eliminate the shortcomings mentioned above.

### SUMMARY OF THE INVENTION

The present invention relates to a ratchet wrench and comprises a body having a through hole defined through the top and the bottom thereof. The through hole has a first recess defined in the inner periphery thereof. The center of the first recess is located in the through hole. The diameter of the first recess is smaller than the diameter of the through hole. A second recess is defined in the inner periphery of the first recess. The diameter of the second recess is smaller than the diameter of the first recess. The first recess is opened to the top and the bottom of the body. The second recess is opened to the top of the body and has a closed portion formed on the bottom of the body. An opening communicates with the lower end of the second recess. A first contact face and a second contact face are defined in two sides of the opening. Each of the first and second contact faces is a recessed and curved face. A top recessed area is defined in the top of the body and shares a common axis with the through hole. The top recessed area communicates with the first recess. A bottom recessed area is defined in the bottom of the body and shares the common axis with the through hole.

A ratchet wheel is rotatably received in the through hole and has a ratchet portion defined in the outer periphery thereof. A connection portion is defined through the ratchet wheel. A first pivotal portion and a second pivotal portion are respectively formed on two ends of the ratchet wheel. The first pivotal portion has a top groove. The second pivotal portion has a bottom groove. The first pivotal portion is pivotably engaged with the top recessed area, and the second pivotal portion is pivotably engaged with the bottom recessed area.

A pawl movably is received in the first recess and has a toothed face defined in the front side thereof. The toothed face is engaged with the ratchet portion of the ratchet wheel. A switch unit is rotatably connected to the second recess to control movement of the pawl in the first recess. A third pivotal portion is formed on one end of the switch unit and has the same diameter as the switch unit.

A top ring is received in the top recessed area and contacts a first shoulder formed between the top recessed area and the through hole. The top ring has a fourth pivotal portion defined in the inner periphery thereof. The fourth pivotal portion is pivotably engaged with the first pivotal portion. The top ring has a recessed portion which is defined in the outer periphery of the top ring. The recessed portion is located between two first protrusions. The recessed portion is pivotably connected to the third pivotal portion. The recessed portion and the second recess are co-axially mounted to the third pivotal portion of the switch unit. The two first protrusions close the first recess in the top of the body.

A top clip is engaged with the top recessed area and the top groove and contacts the top ring to restrict the top ring from separating from the ratchet wheel. A bottom ring is engaged with the bottom recessed area and contacts a second shoulder formed between the second recessed area and the through hole. The inner periphery of the bottom ring is pivotably mounted to the second pivotal portion. The bottom ring has a second protrusion extending radially from the outer periphery thereof. The second protrusion closes the recess in the bottom of the body. A bottom clip is engaged with the bottom recessed area and the bottom groove so as to contact the bottom ring. The ratchet wheel is restricted within the through hole by the top ring, the top clip, the bottom ring and the bottom clip.

The primary object of the present invention is to provide a ratchet wrench wherein the first and second recesses both have an open top which allows the manufacturers to easily make the through hole, the first recess and the second recess.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a front view of the body of the ratchet wrench of the present invention;

FIG. 3 is a cross sectional view, taken along line 3-3 in FIG. 2;

FIG. 4 is a perspective view to show the body of the ratchet wrench of the present invention;

FIG. 5 is an exploded view of the switch unit of the ratchet wrench of the present invention;

FIG. 6 is a perspective view to show the body of the ratchet wrench of the present invention;

FIG. 7 is a side view of the body of the ratchet wrench of the present invention;

FIG. 8 is a cross sectional view, taken along line 8-8 in FIG. 7;

FIG. 9 is a front view of the ratchet wrench of the present invention;

FIG. 10 is a cross sectional view, taken along 10-10 in FIG. 9;

FIG. 11 is an enlarged view of the circled D in FIG. 10;

FIG. 12 is an exploded view of the second embodiment of the ratchet wrench of the present invention;

FIG. 13 is a front view of the second embodiment of the ratchet wrench of the present invention;

FIG. 14 is a cross sectional view, taken along 14-14 in FIG. 13, and

FIG. 15 is an enlarged view of the circled D in FIG. 14.

### DETAILED DESCRIPTION OF THE PREFERRED EMBODIMENT

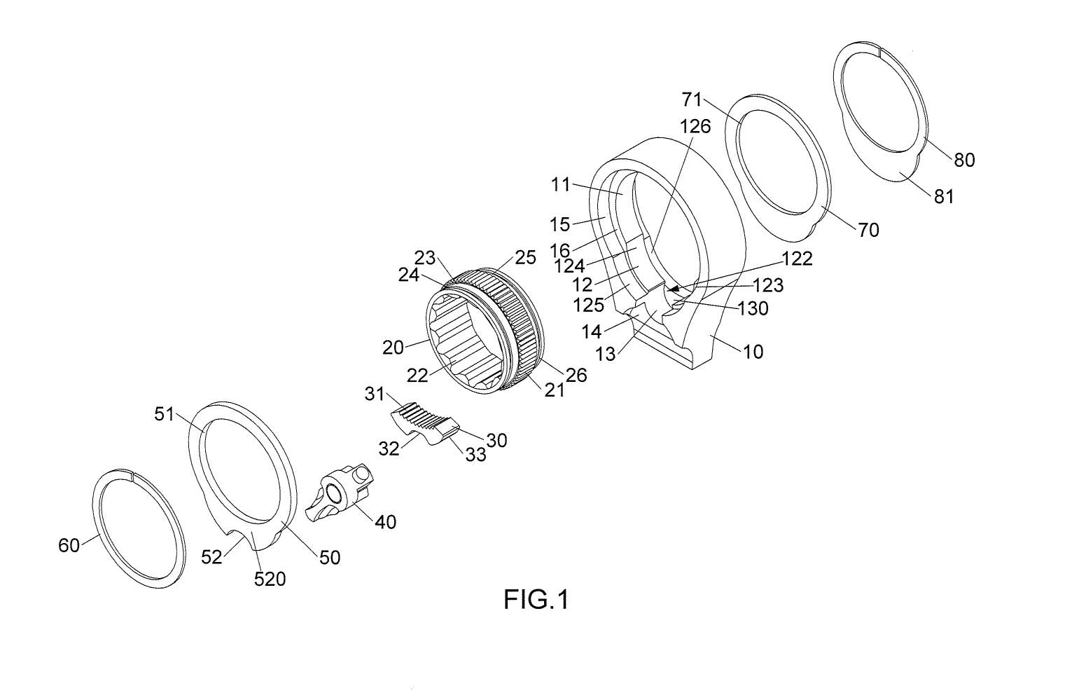

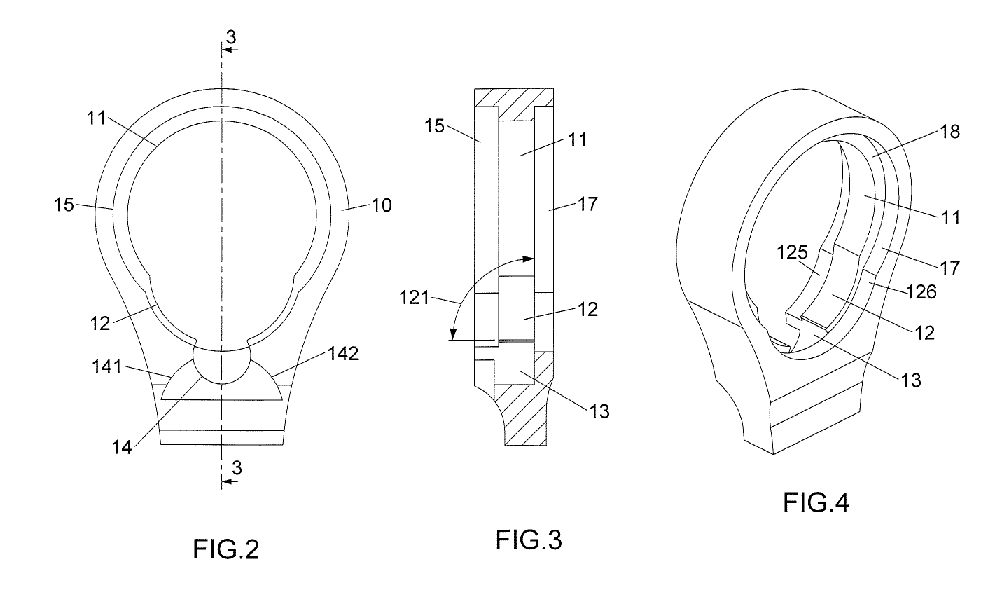

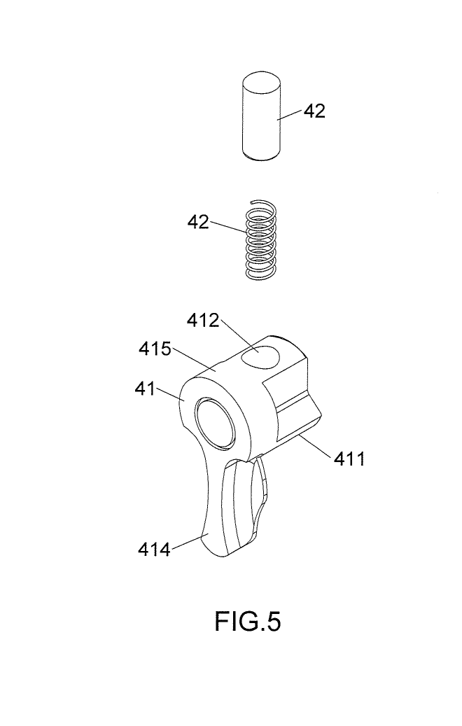

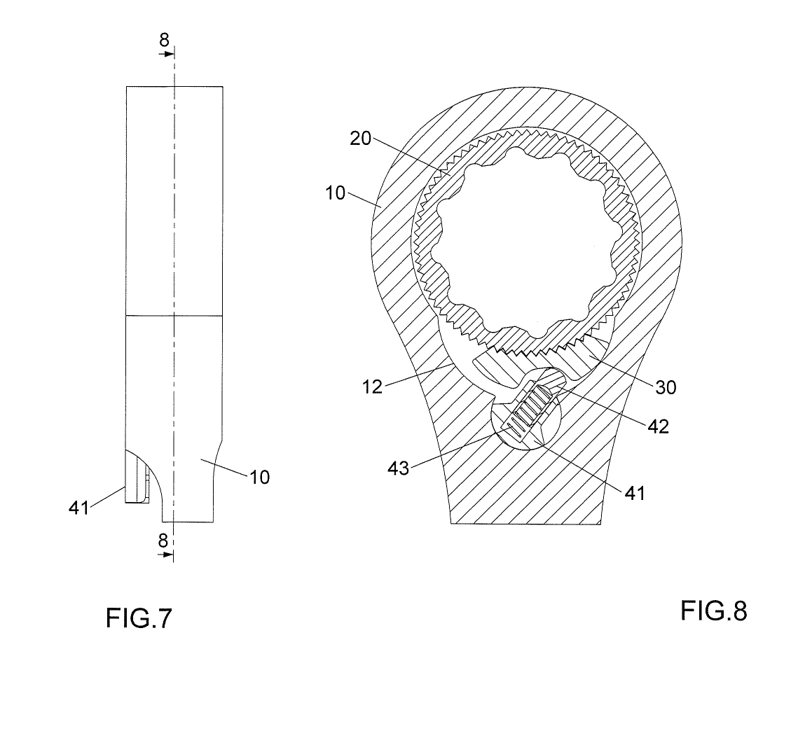

Referring to FIGS. 1, and 5 to 9, the ratchet wrench of the present invention comprises a body 10 having a through hole 11 defined through the top and the bottom thereof. The through hole 11 has a first recess 12 defined in the inner periphery thereof, and a center of the first recess 12 is located in the through hole 11. The diameter of the first recess 12 is smaller than the diameter of the through hole 11. The first recess 12 has a open lower end thereof. An angle 121 is defined between the inner end of the first recess 12 and the inner periphery of the first recess 12. The angle 121 is between 90 to 120 degrees. The first recess 12 includes a middle section 122 and two end sections 123, 124, the two end sections 123, 124 are connected two ends of the middle section 122. The middle section 122 and the two end sections 123, 124 are formed along the inner periphery of the first recess 12. A second recess 13 defined in the inner periphery of the middle section 122 of the first recess 12. The diameter of the second recess 13 is smaller than the diameter of the first recess 12. The first recess 12 is opened to the top and the bottom of the body 10. The second recess 13 is opened to the top of the body 10 and having a closed portion 130 formed on the bottom of the body 10. An opening 14 communicates with the lower end of the second recess 13. A first contact face 141 and a second contact face 142 are defined in two sides of the opening 14. Each of the first and second contact faces 141 and 142 are a recessed and curved face. A top recessed area 15 is defined in the top of the body 10 and shares a common axis with the through hole 11. The top recessed area 15 communicates with the first recess 12. A bottom recessed area 17 is defined in the bottom of the body 10 and shares the common axis with the through hole 11. The first recess 12 in the top of the body 10 includes two first extended recesses 125 which communicate with the opening 14. The first recess 12 in the bottom of the body 10 includes two second extended recesses 126 which communicate with the opening 14. The first protrusions 520 of the top ring 50 match the two first extended recesses 125. The top recessed area 15 and the bottom recessed area 17 are symmetrically located relative to the first hole 11. The inner diameter of the top recessed area 15 is the same as the inner diameter of the bottom recessed area 17. The inner diameter of each of the first extended recesses 125 is the same as the inner diameter of each of the second extended recesses 126. The first and second extended recesses 125, 126 respectively intersect the top and bottom recessed areas 15, 17. The two second extended recesses 126 are connected to an edge of the closed portion 130.

A ratchet wheel 20 is rotatably received in the through hole 11 and has a ratchet portion 21 defined in the outer periphery thereof. A connection portion 22 is defined through the ratchet wheel 20. The connection portion 22 is a polygonal hole so as to be connected with an object. A first pivotal portion 23 and a second pivotal portion 25 are respectively formed on two ends of the ratchet wheel 20. The outer diameter of the first pivotal portion 23 is smaller than the outer diameter of the ratchet wheel 20. The outer diameter of the second pivotal portion 25 is smaller than the outer diameter of the ratchet wheel 20. The first pivotal portion 23 has a top groove 24, and the second pivotal portion 25 has a bottom groove 26. The first pivotal portion 23 is pivotably engaged with the top recessed area 15, and the second pivotal portion 25 is pivotably engaged with the bottom recessed area 17. The first and second pivotal portions 23, 25 are symmetrically located relative to the ratchet wheel 20.

A pawl 30 is movably received in the first recess 12 and has a toothed face 31 defined in the front side thereof. The toothed face 31 is engaged with the ratchet portion 21 of the ratchet wheel 20. The pawl 30 has a notch 32 defined in the middle portion of the rear side thereof. The pawl 30 has a contact end 33 defined each of two ends thereof. Either one of the two contact ends 33 selectively contacts the inner periphery of the first recess 12. A second angle is defined between the contact end 33 and the rear side of the pawl 30 that faces the inner end of the first recess 12. The second angle is matched with the angle 121.

A switch unit 40 is rotatably connected to the second recess 13 to control movement of the pawl 30 in the first recess 12. The switch unit 40 includes a switch member 41, a cap 42 and a resilient member 43. The switch member 41 has a cylindrical member 411 which is pivotably located in the second recess 13. The cylindrical member 411 has a reception hole 412 which faces the notch 32. A lever 414 extends radially from the cylindrical member 411 which is pivotably located in the opening 14. Two sides of the lever 411 are shaped to be matched with the first contact face 141 and the second contact face 142. A third pivotal portion 415 is formed on one end of the cylindrical member 411 and has the same diameter as the switch unit 40 cylindrical member 411. The resilient member 43 and the cap 42 are received in the reception hole 412. The resilient member 43 is biased between the inner end of the reception hole 412 and the cap 42 which is engaged with the notch 32 of the pawl 30.

A top ring 50 is received in the top recessed area 15 and contacts a first shoulder 16 formed between the top recessed area 15 and the through hole 11. The top ring 50 has a fourth pivotal portion 51 defined in the inner periphery thereof. The fourth pivotal portion 51 is pivotably engaged with the first pivotal portion 23. The top ring 50 has a recessed portion 52 which is defined in the outer periphery of the top ring 50. The recessed portion 52 is located between two first protrusions 520. The recessed portion 52 is pivotably connected to the third pivotal portion 415. The recessed portion 52 and the second recess 13 are co-axially mounted to the third pivotal portion 415 of the switch unit 40. The two first protrusions 520 close the first recess 12 in the top of the body 10. The top ring 50 contacts the cap 42 to locate the switch unit 40 in the second recess 13.

A top clip 60 is engaged with the top recessed area 15 and the top groove 24 and contacts the top ring 50 to restrict the top ring 50 from separating from the ratchet wheel 20.

A bottom ring 70 is engaged with the bottom recessed area 17 and contacts a second shoulder 18 formed between the second recessed area 17 and the through hole 11. An inner periphery 71 of the bottom ring 70 is pivotably mounted to the second pivotal portion 25. The bottom ring 70 has a second protrusion 72 extending radially from the outer periphery thereof. The second protrusion 72 closes the recess 12 in the bottom of the body 10.

A bottom clip 80 is engaged with the bottom recessed area 17 and the bottom groove 26 so as to contact the bottom ring 70. The ratchet wheel 20 is restricted within the through hole 11 by the top ring 50, the top clip 60, the bottom ring 70 and the bottom clip 80. The bottom clip 80 further includes a third protrusion 81 extending radially from the outer periphery thereof. The third protrusion 81 is overlapped onto the second protrusion 72. The outside of the second protrusion 72 and the outside of the third protrusion 81 contact the second extended recesses 126.

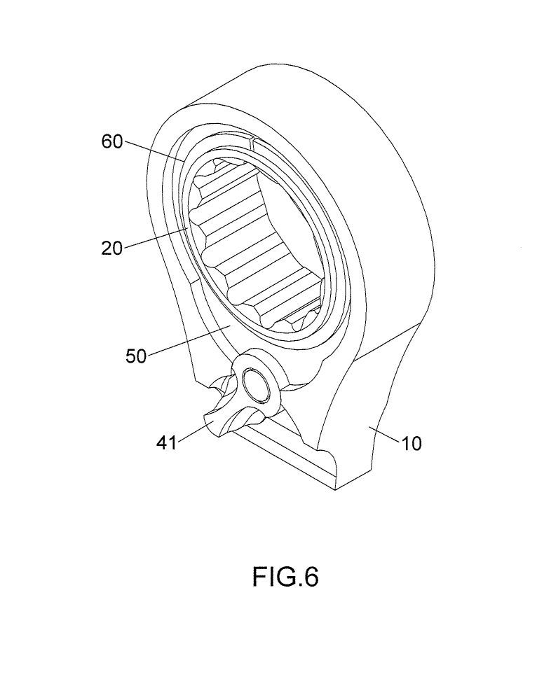

As shown in FIGS. 6 to 8, the switch unit 40 is pivotably received in the second recess 13. The cap 42 is biased by the resilient member 43 and engaged with the notch 32 of the pawl 30. When the users pivot the lever 414, the toothed face 31 is engaged with the ratchet portion 21. the switch unit 40 is pivoted to control the movement of the pawl 30 so as to control the torque output from the ratchet wrench.

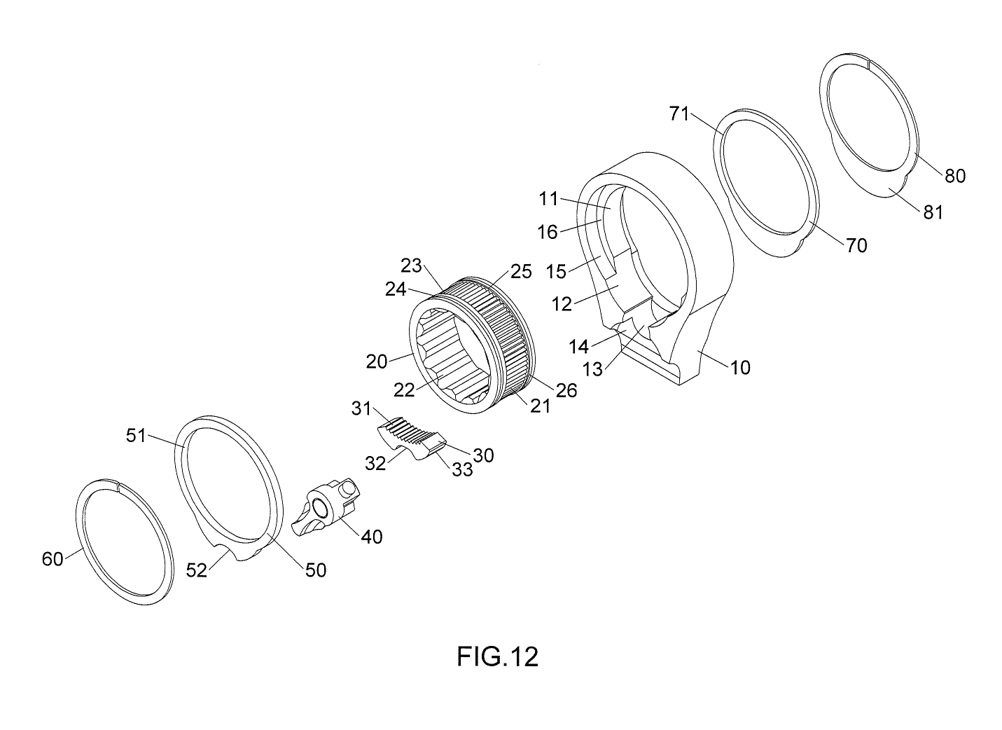

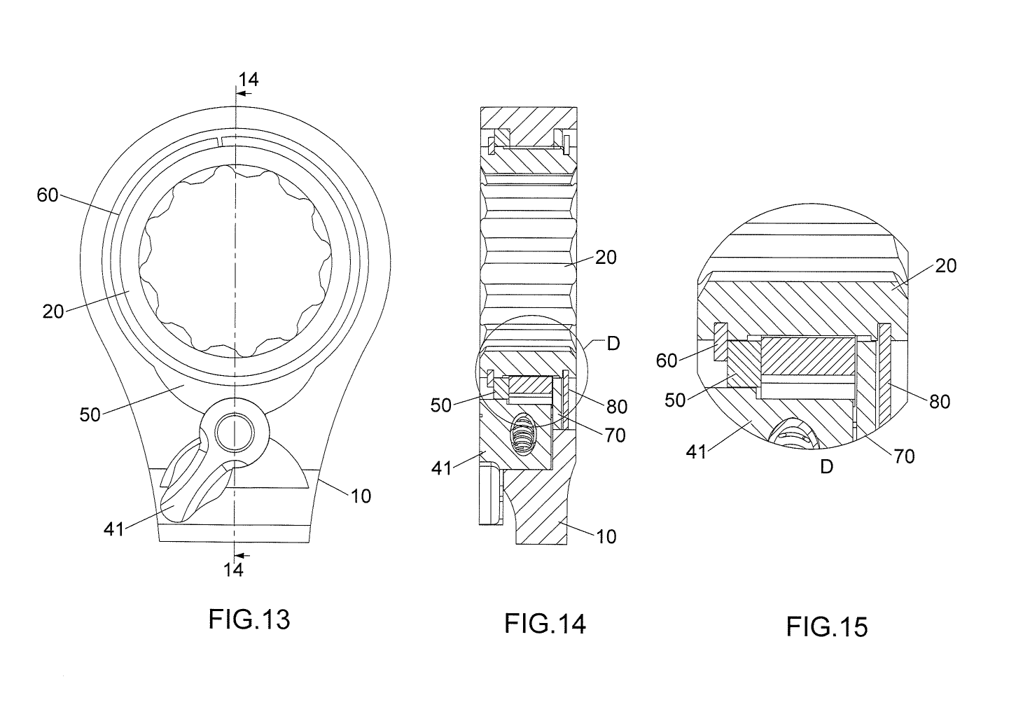

FIGS. 12 to 15 show the second embodiment of the present invention, the first recess 12 includes a section that extends to the top of the body 10. That is to say, there are no first extended recesses 125 as disclosed in FIG. 1 in the second embodiment. The two respective inner diameters of the first and second pivotal portions 23, 25 are then same, and are larger than then diameter of the ratchet portion 21. The connection portion 22 is a rectangular protrusion.

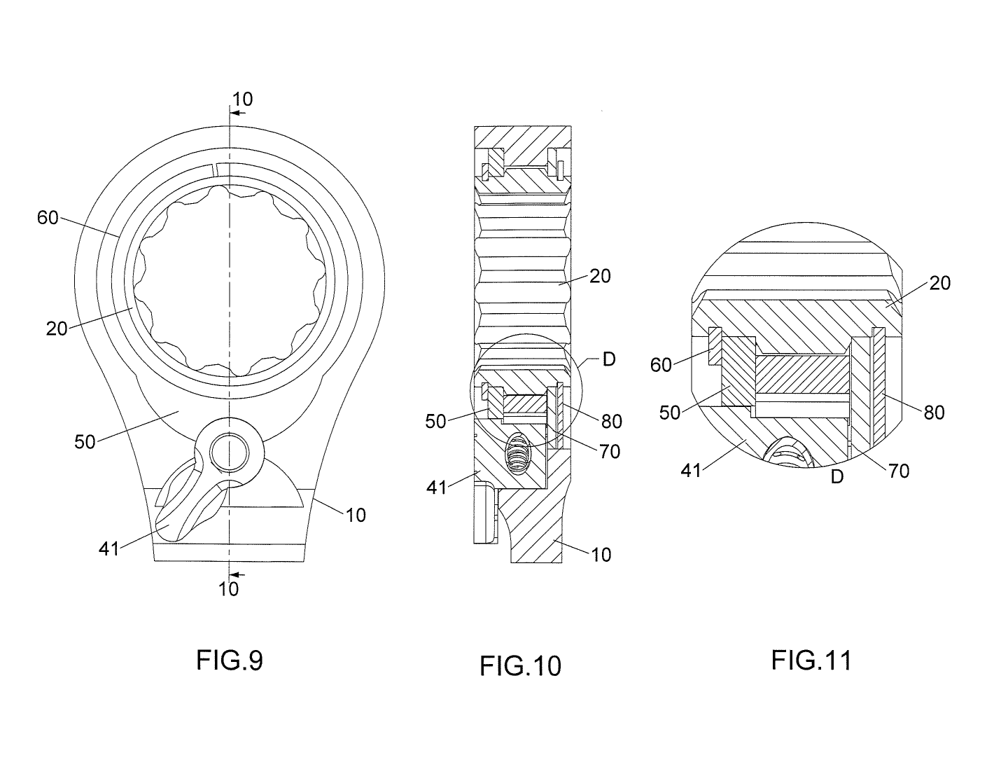

The advantages of the present invention are that the first and second recesses 12, 13 both have an open top so that the tool is easily operated to make the first and second recesses 12, 13. The through hole 11 is defined through the top and the bottom of the body 10 so that the tool does not need to control the cutting depth when drilling the through hole 11. The through hole 11, the first recess 12 and the second recess 13 can be made by the same tool so that accumulated tolerance can be avoided. The through hole 11, the first recess 12 and the second recess 13 all have the same open top so that the body 10 can be made by way of pressing within one time of press. The body 10 can be made by different methods according to practical need. As shown in FIG. 9, when the switch unit 40 is pivoted to control the movement of the pawl 30 in the first recess 12, the two sides of the lever 414 contact the first and second contact faces 141, 142 to restrict the maximum angle that the switch member 41 is pivoted within the second recess 13. The switch member 41 is pivotably received in the semi-circular second recess 13, and the third pivotal portion 415 is pivotably connected to the fourth pivotal portion 52, so that the switch member 41 is stably positioned. The top and bottom clips 60, 70 make the assemblers to conveniently assemble the ratchet wrench. The top clip 60 position the top ring 50 to the top groove 24 to allow the ratchet wheel 20, the pawl 30 and the resilient member 43 to be received in the body 10. The bottom clip 70 is used to pivotably position the ratchet wheel 20.

The first pivotal portion 23 is pivotably connected to the fourth pivotal portion 51, and the second pivotal portion 25 is pivotably received in the through hole 11, so that the ratchet wheel 20 is stably located. The ratchet wheel 20 is easily removed from the through hole 11 by removing the top clip 60 or the bottom clip 70.

As shown in FIG. 11, the two sides of the ratchet wheel 20 are positioned by the top ring 50, the top clip 60, the bottom ring 70 and the bottom clip 80, and supported by the first and second shoulders 16, 18. This arrangement is easily to be assembled and dis-assembled.

The first pivotal portion 23 is pivotally engaged with the fourth pivotal portion 51. The second pivotal portion 25 is pivotally engaged with the inner periphery 71. The ratchet wheel 20 is pivotably supported on two ends thereof so that the ratchet wheel 20 is well positioned.

While we have shown and described the embodiment in accordance with the present invention, it should be clear to those skilled in the art that further embodiments may be made without departing from the scope of the present invention.

What is claimed is:

1. A ratchet wrench comprising:
a body having a through hole defined through a top and a bottom thereof, the through hole having a first recess defined in an inner periphery thereof, a center of the first recess located in the through hole, a diameter of the first recess being smaller than a diameter of the through hole, a second recess defined in an inner periphery of the first recess, a diameter of the second recess being smaller than the diameter of the first recess, the first recess being opened to the top and the bottom of the body, the second recess being opened to the top of the body and having a closed portion formed on the bottom of the body, an opening communicating with a lower end of the second recess, a first contact face and a second contact face defined in two sides of the opening, each of the first and second contact faces being a recessed and curved face, a top recessed area defined in the top of the body and sharing a common axis with the through hole, the top recessed area communicating with the first recess, a bottom recessed area defined in the bottom of the body and sharing the common axis with the through hole;
a ratchet wheel rotatably received in the through hole and having a ratchet portion defined in an outer periphery thereof, a connection portion defined through the ratchet wheel, a first pivotal portion and a second pivotal portion respectively formed on two ends of the ratchet wheel, the first pivotal portion having a top groove, the second pivotal portion having a bottom groove, the first pivotal portion pivotably engaged with the top recessed area, the second pivotal portion pivotably engaged with the bottom recessed area;
a pawl movably received in the first recess and having a toothed face defined in a front side thereof, the toothed face engaged with the ratchet portion of the ratchet wheel;
a switch unit rotatably connected to the second recess to control movement of the pawl in the first recess, a third pivotal portion formed on an end of the switch unit and having the same diameter as the switch unit cylindrical member;
a top ring received in the top recessed area and contacting a first shoulder formed between the top recessed area and the through hole, the top ring having a fourth pivotal portion defined in an inner periphery thereof, the fourth pivotal portion being pivotably engaged with the first pivotal portion, the top ring having a recessed portion which is defined in an outer periphery of the top ring, the recessed portion located between two first protrusions, the recessed portion being pivotably connected to the third pivotal portion, the recessed portion and the second recess co-axially mounted to the third pivotal portion of the switch unit, the two first protrusions closing the first recess in the top of the body;
a top clip engaged with the top recessed area and the top groove and contacting the top ring to restrict the top ring from separating from the ratchet wheel;
a bottom ring engaged with the bottom recessed area and contacting a second shoulder formed between the second recessed area and the through hole, an inner periphery of the bottom ring pivotably mounted to the second pivotal portion, the bottom ring having a second protrusion extending radially from an outer periphery thereof, the second protrusion closing the recess in the bottom of the body, and
a bottom clip engaged with the bottom recessed area and the bottom groove so as to contact the bottom ring, the ratchet wheel being restricted within the through hole by the top ring, the top clip, the bottom ring and the bottom clip.

2. The ratchet wrench as claimed in claim 1, wherein an angle is defined between the inner end of the first recess and the inner periphery of the first recess, the angle is between 90 to 120 degrees.

3. The ratchet wrench as claimed in claim 2, wherein the angle is between 90 to 100 degrees.

4. The ratchet wrench as claimed in claim 1, wherein the top recessed area and the bottom recessed area are symmetrically located relative to the first hole.

5. The ratchet wrench as claimed in claim 1, wherein the connection portion is a polygonal hole or a rectangular protrusion.

6. The ratchet wrench as claimed in claim 1, wherein an outer diameter of the first pivotal portion is smaller than an outer diameter of the ratchet wheel.

7. The ratchet wrench as claimed in claim 1, wherein an outer diameter of the second pivotal portion is smaller than an outer diameter of the ratchet wheel.

8. The ratchet wrench as claimed in claim 1, wherein an outer diameter of the first pivotal portion is the same as an outer diameter of the second pivotal portion, the first and second pivotal portions are symmetrically located relative to the ratchet wheel.

9. The ratchet wrench as claimed in claim 1, wherein the pawl has a notch defined in a middle portion of a rear side thereof, the pawl has a contact end defined each of two ends thereof, either one of the two contact ends selectively contacts the inner periphery of the first recess, the switch unit includes a switch member, a cap and a resilient member, the switch member has a cylindrical member which is pivotably located in the second recess, the cylindrical member has a reception hole which faces the notch, a lever extends radially from the cylindrical member which is pivotably located in the opening, two sides of the lever are shaped to be matched with the first contact face and the second contact face, the third pivotal portion is formed on one end of the cylindrical member, the resilient member and the cap are received in the reception hole, the resilient member is biased between an inner end of the reception hole and the cap which is engaged with the notch of the pawl.

10. The ratchet wrench as claimed in claim 1, wherein the top clip and the bottom clip each are a resilient clip.

11. The ratchet wrench as claimed in claim 9, wherein the top ring contacts the cap to locate the switch unit in the second recess.

12. The ratchet wrench as claimed in claim 1, wherein an outer diameter of the first pivotal portion is the same as an outer diameter of the second pivotal portion, the two respective diameters of the first pivotal portion and the second pivotal portion are larger than a diameter of the ratchet portion.

13. The ratchet wrench as claimed in claim 1, wherein an inner diameter of the top recessed area is the same as an inner diameter of the bottom recessed area.

14. The ratchet wrench as claimed in claim 1, wherein the first recess in the top of the body includes two first extended recesses which communicate with the opening, the first recess in the bottom of the body includes two second extended recesses which communicates with the opening, the first protrusions of the top ring match the two first extended recesses.

15. The ratchet wrench as claimed in claim 14, wherein the bottom clip includes a third protrusion extending radially from an outer periphery thereof, the third protrusion is overlapped onto the second protrusion, an outside of the second protrusion and an outside of the third protrusion contact the second extended recesses.
